(19) United States
(12) Patent Application Publication
(10) Pub. No.: US 2026/0024253 A1
(43) Pub. Date: Jan. 22, 2026

(54) IMAGE GENERATION DEVICE AND IMAGE GENERATION PROGRAM

(71) Applicant: TOYOTA JIDOSHA KABUSHIKI KAISHA, Toyota-shi (JP)

(72) Inventor: Lukasz Kamil MAJEWSKI, Chiba-shi (JP)

(73) Assignee: TOYOTA JIDOSHA KABUSHIKI KAISHA, Toyota-shi (JP)

(21) Appl. No.: 19/204,754

(22) Filed: May 12, 2025

(30) Foreign Application Priority Data
Jul. 16, 2024 (JP) 2024-113447

(51) Int. Cl. G06T 11/60; G06V 20/56

(52) U.S. Cl. CPC G06T 11/60; G06V 20/588

(57) ABSTRACT

An image generation device for generating image data representing consecutive images for training, includes a processor. The processor is configured to: acquire image data representing consecutive captured images in which a road is captured; three-dimensionally recognize an area of a road in each captured image; designate an initial object drawing area at an arbitrary position among recognized areas of a road, in an initial image; designate a subsequent object drawing area to a position where it corresponds to the initial object drawing area, in a subsequent image; and generate data of an image obtained by adding an additional image of an arbitrary object to the object drawing area designated in each image of the consecutive captured images.

### FIELD

The present disclosure relates to an image generation device and an image generation program.

### BACKGROUND

Conventionally, there has been known a training device for training a model for determining an object existing on a road (JP2022-154193A). In the training device described in JP2022-154193A, a computer graphic image (CG image) of an object existing on a road is added to a captured image in which the road is captured, and the image is used as an image for training data. In particular, in the training device described in JP2022-154193A, when a CG image of an object is added to a captured image, a position and a size at which a CG image is added are changed based on a moving amount of the vehicle.

In addition, conventionally, it is known that a learning model for estimating three-dimensional coordinates of an object is generated from image data using a feature point map with depth information as training data, and image data obtained by capturing an object in such a learning model is implanted to estimate three-dimensional coordinates of the object (JP2021-117130A).

Incidentally, in JP2022-154193A, in the image following the image to which CG image is first added, the position to which CG image is to be added is automatically specified based on the move distance of the vehicle. However, when a CG image is first added to any captured image, the position where CG image is added needs to be artificially identified. Therefore, it takes time and effort to generate an image to which an object is added.

### SUMMARY

In view of the above problems, an object of the present disclosure is to reduce the time and effort of a user in generating image data for training data.

The gist of the present disclosure is as follows.
(1) An image generation device for generating image data representing consecutive images for training, comprising a processor, the processor being configured to:
   acquire image data representing consecutive captured images in which a road is captured from different image capturing points;
   three-dimensionally recognize an area of a road in each captured image represented by the image data;
   designate an initial object drawing area at an arbitrary position within a predetermined distance range that is visible by a driver among recognized areas of a road, in an initial image which is one image of the consecutive captured images;
   designate a subsequent object drawing area to a position where it corresponds to the initial object drawing area, in a subsequent image which follows the initial image among the consecutive captured images; and
   generate data of an image obtained by adding an additional image of an arbitrary object to the object drawing area designated in each image of the consecutive captured images.
(2) The image generation device according to above (1), wherein the processor is configured to designate, as the initial object drawing area, an area farthest from an image capturing point within a predetermined distance range that is visible by a driver.
(3) The image generation device according to above (1) or (2), wherein the processor is configured to generate image data representing an additional image of an arbitrary object from random noise based on text input, generates data of an image obtained by adding the additional image representing the object to the object drawing area, and generate, in the subsequent image, image data representing an additional image added in the subsequent image from random noise identical to the random noise used for generating image data representing an additional image added in the initial image.
(4) The image generation device according to above (3), wherein the processor is configured to generate the image data based on a text input having the same content as a text input used to generate the image data representing the additional image to be added in the initial image except for a text relating to an appearance of the object of the additional image to be added in the subsequent image.
(5) A non-transitory recording medium having recorded thereon an image generation program for generating image data representing consecutive images for training, comprising:
   acquiring image data representing consecutive captured images in which a road is captured from different image capturing points;
   three-dimensionally recognizing an area of a road in each captured image represented by the image data;
   designating an initial object drawing area at an arbitrary position within a predetermined distance range which is visible by a driver among the recognized areas of a road, in an initial image which is one image of the consecutive captured images;
   designating a subsequent object drawing area to a position where it corresponds to the initial object drawing area, in a subsequent image which follows the initial image among the consecutive captured images; and
   generating data of an image obtained by adding an additional image of an arbitrary object to the object drawing area designated in each image of the consecutive captured images.

### BRIEF DESCRIPTION OF DRAWINGS

FIG. 1 is a configuration diagram schematically illustrating an image generation device according to an embodiment.

FIG. 2 is a diagram schematically illustrating a vehicle that transmits image data used in an image generation device to the image generation device.

FIG. 3 is a diagram illustrating a state in which a road is recognized by a road recognition unit in one captured image.

FIG. 4 is a view similar to FIG. 3, showing a visible area specified by the initial area designation unit in one captured image.

FIGS. 5A and 5B schematically illustrate masks applied to arbitrary images.

FIGS. 6A and 6B are diagrams illustrating images in which an additional image generated using an image generation AI is added.

FIG. 7 is a flowchart illustrating a flow of image generation processing.

### DESCRIPTION OF EMBODIMENTS

Hereinafter, embodiments will be described in detail with reference to the drawings. In the following description, the same reference numerals are given to the same constituent elements.

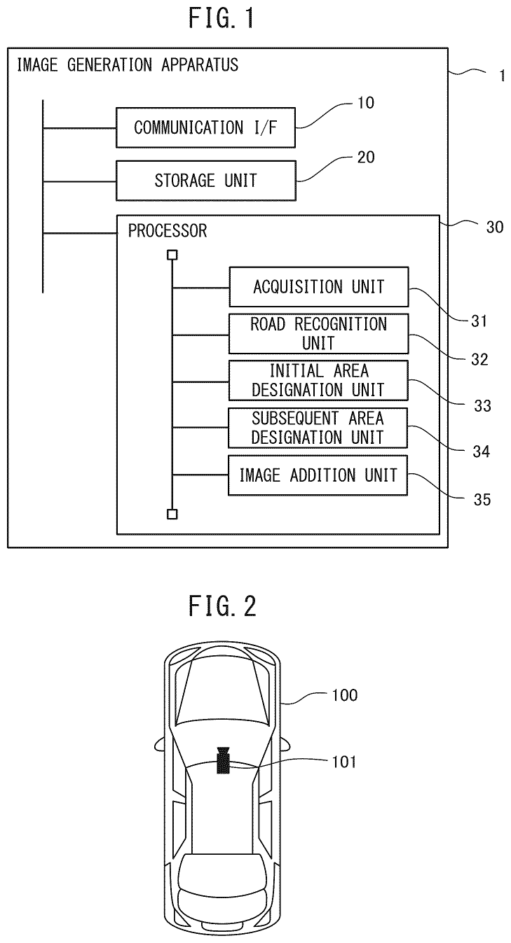

A configuration of an image generation device 1 will be described with reference to FIGS. 1 and 2. FIG. 1 is a configuration diagram schematically illustrating the image generation device 1 according to an embodiment. The image generation device 1 generates image data representing a consecutive image (that is, a moving image) for use as training data in the training of a machine learning model.

In the present embodiment, the machine learning model is a model for determining an object (obstacle) on a road in an image in front of a vehicle captured by an outside camera attached to the vehicle. Therefore, when data of an image captured by the outside camera is input, the machine learning model outputs the position of an object (for example, a load, a tire, a cardboard box, a rock, a branch, or the like), if the object is present on a road as an obstacle in an image represented by the data.

In the training of such a machine learning model, image data of images in which an obstacle is present on a road and which is consecutive captured images in front of a vehicle captured by an outside camera, is required as training data. However, it is difficult to actually capture and prepare a large number of consecutive captured images in which such obstacles actually appear. Therefore, the image generation device 1 generates an image obtained by adding an additional image of an arbitrary obstacle to consecutive captured images captured by the outside camera of the vehicle while traveling. As a result, it is possible to generate an image in which an obstacle exists on the road even if an obstacle does not appear in the captured image captured by the outside camera, and it is possible to reduce the burden of generating the training data used in the machine learning model as described above.

FIG. 2 is a diagram schematically illustrating a vehicle 100 that transmits image data used in the image generation device 1 to the image generation device 1. As illustrated in FIG. 2, the vehicle 100 includes an outside camera 101 that captures an image of the front of the vehicle 100. The image generation device 1 may be mounted on the vehicle 100 or may be formed in a server capable of communicating with the vehicle 100.

In the present embodiment, the outside camera 101 is disposed inside the front glass of the vehicle 100 and captures an image of the front of the vehicle 100. Therefore, the outside camera 101 captures an image of the road ahead of the vehicle while the vehicle 100 is traveling. The outside camera 101 captures an image of the front of the vehicle 100 at every predetermined capturing cycle, and generates image data of consecutive images in which the front of the vehicle 100 appears.

As illustrated in FIG. 1, the image generation device 1 includes a communication interface 10, a storage unit 20, and a processor 30. Note that the communication interface 10, the storage unit 20, and the processor 30 may be separate circuits or may be configured as one integrated circuit.

The communication interface 10 is an interface circuit for connecting the image generation device 1 to an external apparatus of the image generation device 1. The image generation device 1 transmits and receives data to and from an external device via the communication interface 10. The external device includes, for example, an outside camera 101 of any vehicle 100 or a vehicle storage device (not shown) that stores data of images captured by such an outside camera 101. Further, the external device includes a training device that causes a machine learning model to be trained. In addition, the external device may include an input device (e.g., keyboard, mouse, etc.) by the user and an output device (e.g., display, speaker, etc.) to the user. In the present embodiment, the communication interface 10 receives data of an image in front of the vehicle while the vehicle 100 is traveling, captured by the outside camera 101, from the outside camera 101 or the vehicle storage device of an arbitrary vehicle 100, and stores the data in the storage unit 20. Further, the communication interface 10 transmits the image data for training generated by the image generation device 1 to a learning device.

The storage unit 20 is a non-transitory storage medium that stores data. The storage unit 20 includes, for example, at least one of a volatile semiconductor memory, a nonvolatile semiconductor memory, a hard disk drive (HDD), and a solid state drive (SSD). The storage unit 20 stores a computer program executed by the processor 30, in particular, an image generation program for executing an image generation process. Further, the storage unit 20 stores data used in a computer program executed by the processor 30, such as data of an image in front of the vehicle 100 received from the outside via the communication interface 10. In addition, the storage unit 20 stores data of an image generated by the processor 30.

The processor 30 includes one or more CPU (Central Processing Unit) and its peripheral circuitry. The processor 30 may further include other arithmetic circuits such as a logical arithmetic unit or a numerical value arithmetic unit. The processor 30 executes a computer program stored in the storage unit 20. In particular, in the present embodiment, the processor 30 executes the image generation program stored in the storage unit 20.

As illustrated in FIG. 1, the processor 30 includes an acquisition unit 31, a road recognition unit 32, an initial area designation unit 33, a subsequent area designation unit 34, and an image addition unit 35. These units included in the processor 30 are, for example, functional modules realized by a computer program running on the processor 30. Alternatively, the units included in the processor 30 may be implemented in the image generation device 1 as independent integrated circuits, microprocessors, or firmware.

The acquisition unit 31 acquires image data representing consecutive captured images obtained by capturing roads from different image capturing points. In the present embodiment, image data of a consecutive captured image captured by the outside camera 101 of the traveling vehicle 100 is stored in the storage unit 20 via the communication interface 10. Therefore, the acquisition unit 31 acquires image data of such a consecutive captured image stored in the storage unit 20 from the storage unit 20. Such consecutive captured image data is captured while the vehicle 100 is traveling, and thus represents a consecutive captured image in which roads are captured from different image capturing points by small distances.

The road recognition unit 32 three-dimensionally recognizes the area of the road in each captured image represented by the image data acquired by the acquisition unit 31. In the present embodiment, images are captured from different image capturing points by small distances in consecutive captured images represented by the image data. As a result, in the present embodiment, the road recognition unit 32 three-dimensionally recognizes the area of the road on the basis of the image data acquired by the acquisition unit 31 without using distance data (for example, detected data of a distance measuring sensor such as a LiDAR or a millimeter-wave radar) to an object in front of the vehicle 100 when the image data is captured. That is, in the present embodiment, the road recognition unit 32 three-dimensionally recognizes the area of the road in each captured image based only on the image data representing the consecutive captured image acquired by the acquisition unit 31. In particular, in the present embodiment, the road recognition unit 32 uses a three-dimensional recognition model such as SfM (Structure from Motion) to three-dimensionally recognize areas of roads in each of the captured images from image data representing the consecutive captured images.

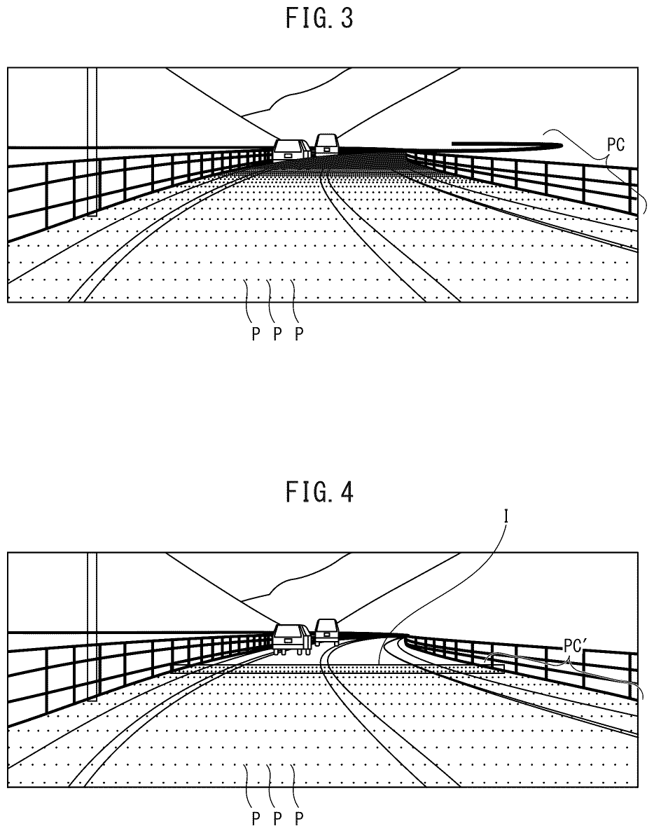

FIG. 3 is a diagram illustrating a state in which a road is recognized by the road recognition unit 32 in one captured image. In FIG. 3, the road recognized by the road recognition unit 32 is represented by a point cloud PC including a plurality of points P representing a relative three-dimensional position with respect to the vehicle 100 (in particular, with respect to the outside camera 101 of the vehicle 100). That is, in the present embodiment, the road recognition unit 32 calculates the point cloud PC representing the three-dimensional position of the road. Therefore, the road recognition unit 32 three-dimensionally recognizes the area of the road in the captured images represented by the image data acquired by the acquisition unit 31, and outputs the data of the point cloud PC that is the set of the plurality of points P representing the three-dimensional position of the road.

In the present embodiment, a three-dimensional recognition model such as a SfM is used to three-dimensionally recognize roads in the captured image based on image data representing the consecutive captured images. This eliminates the detection data of a distance sensor such as a LiDAR or a millimeter-wave radar in order to recognize a road in the captured images. Therefore, the road can be recognized based on a small amount of data.

In the present embodiment, the road recognition unit 32 uses a SfM to generate data of a point cloud PC representing a road three-dimensionally from image data representing consecutive captured images, and three-dimensionally recognizes the road by the point cloud PC. However, the road recognition unit 32 may use any three-dimensional recognition model other than SfM as long as it can three-dimensionally recognize the area of the road in the captured images based on the image data representing the consecutive captured images.

The initial area designation unit 33 designates an initial object drawing area at an arbitrary position within a predetermined distance range that can be visible by the driver in the recognized area of the road in the initial image that is one of the consecutive captured images.

First, the initial area designation unit 33 sets one of the consecutive captured images included in the image data acquired by the acquisition unit 31 as an initial image (hereinafter, the time at which the initial image appears among the consecutive captured images is set to time t=0). The setting of the initial image by the initial area designation unit 33 may be performed based on an input from the user by the input device. In this case, the user specifies an image to be an initial image by the input device, and the initial area designation unit 33 sets the image specified by the user as an initial image. Alternatively, the initial area designation unit 33 may automatically set the initial image from the consecutive captured images based on a parameter such as the appearance frequency of the obstacle set by the user via the input device.

In addition, when the initial image is set, the initial area designation unit 33 identifies, as a visible area, a area within a distance range that is visible by the driver among the areas in the initial image recognized as having a road by the road recognition unit 32.

FIG. 4 is a view similar to FIG. 3, showing the visible area specified by the initial area designation unit 33 in one captured image. In particular, in the embodiment illustrated in FIG. 4, the area represented by the point cloud PC″ is identified as the visible area. Here, the point cloud PC″ illustrated in FIG. 4 does not include the measuring point P located in the area away from the image capturing point (that is, the outside camera 101 of the vehicle 100) in the point cloud PC illustrated in FIG. 3. Therefore, the point cloud PC″ illustrated in FIG. 4 is a point cloud in which the point P representing a position farther than the predetermined visibility limit distance is removed from the point cloud PC representing the road in three dimensions. Therefore, in the present embodiment, the visible area specified by the initial area designation unit 33 is represented by the point cloud PC″ located at a distance equal to or less than the visibility limit distance from the vehicle 100 among the point cloud PC including the plurality of points P representing the three-dimensional positions of the road.

In the present embodiment, the initial area designation unit 33 designates the initial object drawing area at an arbitrary position within the visible area identified in the above manner. That is, the initial area designation unit 33 designates the object drawing area in the area represented by the point cloud PC″ in FIG. 4.

In particular, in the present embodiment, the initial area designation unit 33 designates, as the initial object drawing area, the area farthest from the image capturing point in the traveling direction of the vehicle 100 among the visible areas. Therefore, the area in the region farthest from the vehicle 100 within the visibility limit distance visible to the driver is designated as the initial object drawing area. In the embodiment illustrated in FIG. 4, the initial object drawing area is designated at any position in the area I that is farthest from the vehicle 100 in the traveling direction of the vehicle 100 among the areas represented by the point cloud PC″.

Here, the object drawing area is an area in which an additional image of an object to be added is drawn. In the present embodiment, the initial area designation unit 33 automatically designates the object drawing area in the initial image. Accordingly, it is possible to save time and effort for the user to designate an area to which an object is to be added, and to reduce time and effort for the user in generating image data for training data. In the present embodiment, the initial area designation unit 33 designates the farthest area among the visible areas as the initial object drawing area. As a result, the object to be added is drawn at the farthest position that the driver is visible, and a natural image is generated without the object to be added suddenly appearing.

The subsequent area designation unit 34 designates a subsequent object drawing area at a position corresponding to the object drawing area in the initial image in the subsequent image following the initial image among the consecutive captured images. As described above, the road recognition unit 32 three-dimensionally recognizes the area of the road, and accordingly, the positional relationship of the road between different images is also recognized. Therefore, when the road recognition unit 32 recognizes the area of the road, a point on the road in another captured image corresponding to an arbitrary point on the road in an arbitrary captured image is recognized. The subsequent area designation unit 34 designates the object drawing area in the subsequent screen based on the positional relationship between the corresponding points in the different captured images recognized in this manner.

Specifically, the subsequent area designation unit 34 designates, in the captured image next to the initial image, the object drawing area at a position corresponding to the object drawing area in the initial image. Then, when an object drawing area is designated in a certain captured image after the initial image, the subsequent area designation unit 34 designates an object drawing area at the position of the next captured image corresponding to the object drawing area, and repeats such an operation. As a result, in the plurality of consecutive captured images, the object drawing area is designated at a position corresponding to each other.

Further, the subsequent area designation unit 34 designates the object drawing area so that the size of the drawing area of the object changes according to the three-dimensional distance from the image capturing point to the object drawing area. Since the consecutive captured images are basically images captured by the vehicle 100 moving forward, the distance from the image capturing point to the object drawing area becomes shorter as the image becomes later. Therefore, the subsequent area designation unit 34 designates the object drawing area such that the object drawing area becomes larger as the image becomes later.

In the present embodiment, the object drawing area in the subsequent image is designated based on the positional relationship between the different images recognized by the road recognition unit 32. As a result, in designating the object drawing area in the subsequent image, the traveling data of the vehicle 100 (for example, data such as the speed and acceleration of the vehicle 100 and the steering angle of the vehicle 100) is unnecessary. Therefore, it is possible to appropriately designate the object drawing area in the subsequent image based on the small amount of data.

The image addition unit 35 generates data of an image obtained by adding an additional image of an arbitrary object to an object drawing area designated in each image of a consecutive captured image. In the present embodiment, the image addition unit 35 generates data of an image obtained by adding an additional image of the same object (obstacle) to each of the consecutive captured images.

In the present embodiment, when a text is input by the user via the input device, the image addition unit 35 generates image data representing an additional image of an arbitrary object according to the text input from random noise based on the text input, and generates data of an image obtained by adding the additional image represented by the image data to the object drawing area. For example, when the user inputs the text “cardboard box”, the image addition unit 35 generates image data of an additional image representing the “cardboard box” according to the text input. Then, the image addition unit 35 generates image data of an additional image obtained by adding the “cardboard box” to the object drawing area of each captured image.

Further, the additional image generated by the image addition unit 35 changes in accordance with the random noise given in the initial stage. Therefore, even if the same text is input by the user, if the random noise given at an initial stage is different, a different image is generated according to the text input. For example, when a “cardboard box” is input in text, image data representing an image of cardboard box having a different shape, color, and printing appearing on the surface of the cardboard box is generated when random noise given at an initial stage is different. On the other hand, when the “cardboard box” is input in text, if the random noise given at the initial stage is the same, image data representing the image of the cardboard box of the same shape, color, and printing is generated.

In the present embodiment, the image addition unit 35 generates image data using an image generation AI model such as a Stable Diffusion. In particular, in a Stable Diffusion, text about an image to be generated in generating an image is inputted by a user, and data representing an image according to the text is generated. In addition, in Stable Diffusion, in generating an image, random noise is input first, and data representing an image according to the input text is generated based on the random noise.

Specifically, the image addition unit 35 first generates data of an image obtained by adding an additional image of an arbitrary object to an initial image at time t=0. The image addition unit 35 generates a mask in which the object drawing area designated by the initial area designation unit 33 is painted in a single color (for example, white). In addition, the image addition unit 35 superimposes the mask generated in this manner on the initial image at time t=0. As a result, an image in which a part of the initial image is painted white by the mask is generated.

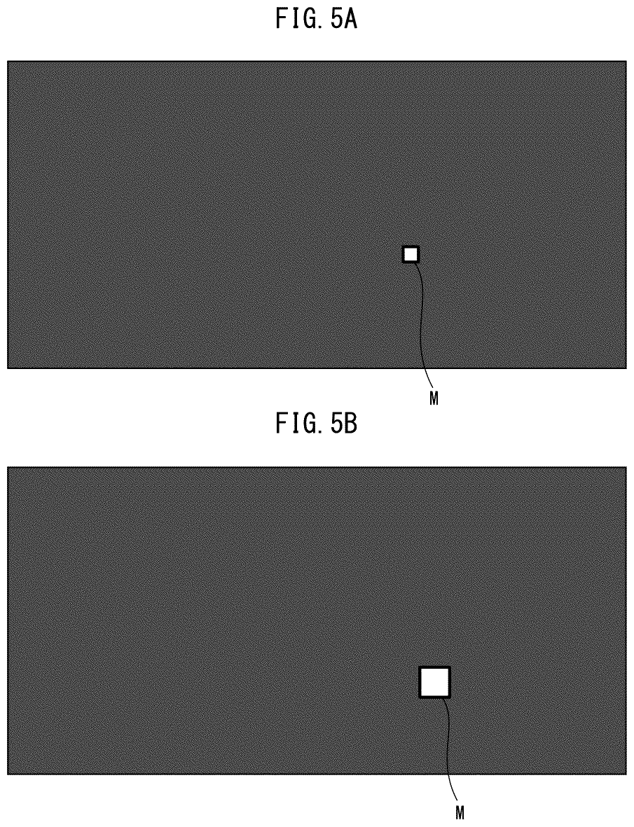

FIGS. 5A and 5B schematically illustrate masks applied to arbitrary images. FIG. 5A shows the mask M added to the initial image at time t=0. As illustrated in FIG. 5A, the mask M added to the initial image at time t=0 is formed in the area designated by the initial area designation unit 33, that is, in the area farthest from the image capturing point among the visible areas.

In addition, the image addition unit 35 adds an additional image generated by using the image generation AI model to the area in which the mask M is provided, based on the text input by the user and optional random noise, for the initial image at time t=0.

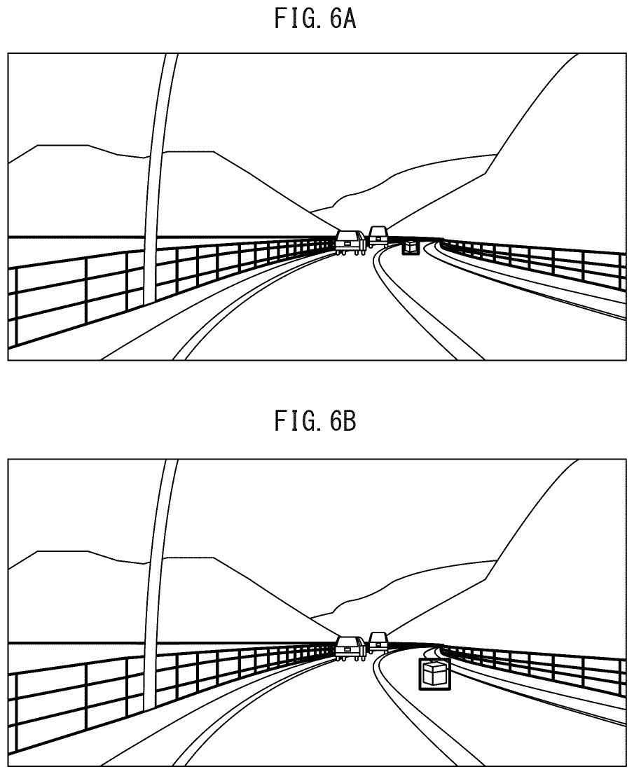

FIGS. 6A and 6B are diagrams illustrating an image in which additional images generated using the image generation AI is added. FIG. 6A shows an image in which the generated additional image (an image surrounded by a square in the drawing) is added to the area of the mask M shown in FIG. 5A in the initial image at time t=0. In particular, in FIG. 6A, an additional image of cardboard box is added. As a result, in the present embodiment, the user can add the additional image according to the text input to the initial image only by inputting the text relating to the image to be added.

Next, the image addition unit 35 generates image data obtained by adding an additional image of an arbitrary object to a subsequent image at each time t=n (n is a value larger than 0) after the time t=0. The image addition unit 35 generates, for each subsequent image, a mask in which the object drawing area designated by the subsequent area designation unit 34 is painted in a single color (for example, white). In addition, the image addition unit 35 superimposes the mask generated in this manner on the subsequent image at time t=n. As a result, an image in which a part of the subsequent image at time t=n is painted white by the mask is generated.

FIG. 5B illustrates a mask M added to a subsequent image at time t=N. As illustrated in FIG. 5B, the mask M added to the subsequent image at time t=n is formed in the area designated by the subsequent area designation unit 34, that is, in the area corresponding to the object drawing area in the initial image.

In addition, the image addition unit 35 adds an additional image generated by using the image generation AI model to the area in which the mask M is provided, based on the text input by the user and optional random noise, for the subsequent image at time t=n.

FIG. 6B shows an image in which a generated image (an image surrounded by squares in the drawing) is added to the area of the mask M shown in FIG. 5B in a subsequent image at time t=n. In the present embodiment, in generating the image data representing the additional image to be added in the subsequent image, the same random noise as the random noise used to generate the image data representing the additional image to be added in the initial image is used. In addition, in the present embodiment, in generating the image data representing the image to be added in the subsequent image, the text input having the same content as the text input used to generate the image data representing the additional image to be added in the initial image is used. As a result, in FIG. 6B, an additional image of cardboard box, which is similar to the additional image of cardboard box in FIG. 6A, is added. As a result, in the present embodiment, the user can add the generated image according to the text input to the subsequent image only once by performing the text input on the image to be added to the series of captured images.

In the above-described embodiment, in generating the image data representing the additional image to be added in the subsequent image, the same text input as the text input used to generate the image data representing the additional image to be added in the initial image is used. However, the text relating to the appearance of the object in the image data representing the additional image to be added may be different for each subsequent image. For example, for the next subsequent image of the initial image, text indicating that the orientation of the object has changed by an arbitrary angle with respect to the initial image may be added to the text for generating the image. As a result, image data including an image of a more appropriate object is generated for the subsequent image. In any case, it can be said that the image addition unit 35 generates the image data on the basis of the text input having the same content as the text input used to generate the image data representing the additional image to be added in the initial image except for the text relating to the appearance of the object in the image data representing the additional image in the subsequent image.

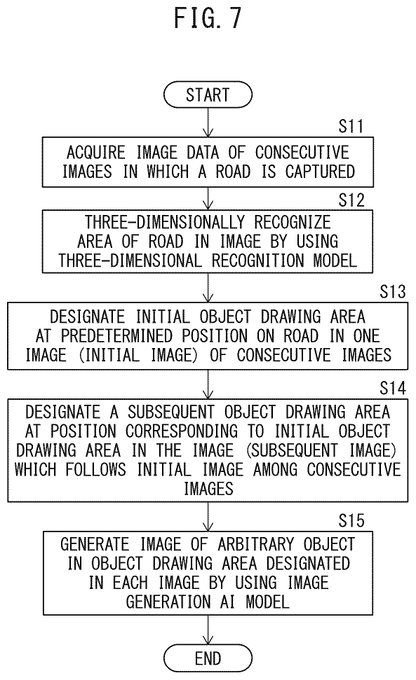

Next, with reference to FIG. 7, a flow of image generation processing for generating consecutive images for training will be described. FIG. 7 is a flowchart illustrating a flow of image generation processing. The image generation processing illustrated in FIG. 7 is executed by the processor 30.

When the image generation process is started, first, the acquisition unit 31 acquires, from the storage unit 20, image data representing consecutive captured images in which a road is captured while the vehicle 100 is traveling (step S11). Therefore, the acquisition unit 31 acquires, for example, a moving image captured while the vehicle 100 is traveling and then transmitted from the vehicle 100 to the image generation device 1 and stored in the storage unit 20.

Next, the road recognition unit 32 three-dimensionally recognizes the area of the road in the respective captured images represented by the image data acquired by the acquisition unit 31, by using a three-dimensional recognition model (for example, a SfM) (step S12). In the present embodiment, the road recognition unit 32 three-dimensionally recognizes the area of the road with respect to all the captured images included in the acquired image data. However, the road recognition unit 32 may three-dimensionally recognize the area of the road only for a part of the consecutive captured images included in the acquired image data.

Next, the initial area designation unit 33 designates an initial object drawing area at a predetermined position recognized by the road recognition unit 32 in one image (initial image) of the consecutive captured images acquired by the acquisition unit 31 (step S13). The initial area designation unit 33 may automatically designate an initial image, or may automatically designate an initial object drawing area.

Next, the subsequent area designation unit 34 designates a subsequent object drawing area at a position corresponding to the initial object drawing area in the subsequent image following the initial image among the consecutive captured images acquired by the acquisition unit 31 (step S14). The subsequent area designation unit 34 automatically designates a subsequent object drawing area.

Next, the image addition unit 35 generates image data of an image obtained by adding an additional image of an arbitrary object to the object drawing area designated by the initial area designation unit 33 and the subsequent area designation unit 34 using the image generation AI model (step S15). The image addition unit 35 generates image data of an image obtained by adding an additional image of the same object to all captured images in which the object drawing area is designated. As a result, consecutive images in which an arbitrary object (obstacle) is present on the road is generated from consecutive captured images of the road in which no obstacle is present on the road.

While preferred embodiments according to the present disclosure have been described above, the present disclosure is not limited to these embodiments, and various modifications and changes can be made within the scope of the claims.

1. An image generation device for generating image data representing consecutive images for training, comprising a processor, the processor being configured to:
acquire image data representing consecutive captured images in which a road is captured from different image capturing points;
three-dimensionally recognize an area of a road in each captured image represented by the image data;
designate an initial object drawing area at an arbitrary position within a predetermined distance range that is visible by a driver among recognized areas of a road, in an initial image which is one image of the consecutive captured images;
designate a subsequent object drawing area to a position where it corresponds to the initial object drawing area, in a subsequent image which follows the initial image among the consecutive captured images; and
generate data of an image obtained by adding an additional image of an arbitrary object to the object drawing area designated in each image of the consecutive captured images.

2. The image generation device according to claim 1, wherein the processor is configured to designate, as the initial object drawing area, an area farthest from an image capturing point within a predetermined distance range that is visible by a driver.

3. The image generation device according to claim 1, wherein the processor is configured to generate image data representing an additional image of an arbitrary object from random noise based on text input, generates data of an image obtained by adding the additional image representing the object to the object drawing area, and generate, in the subsequent image, image data representing an additional image added in the subsequent image from random noise identical to the random noise used for generating image data representing an additional image added in the initial image.

4. The image generation device according to claim 3, wherein the processor is configured to generate the image data based on a text input having the same content as a text input used to generate the image data representing the additional image to be added in the initial image except for a text relating to an appearance of the object of the additional image to be added in the subsequent image.

5. A non-transitory recording medium having recorded thereon an image generation program for generating image data representing consecutive images for training, comprising:
acquiring image data representing consecutive captured images in which a road is captured from different image capturing points;
three-dimensionally recognizing an area of a road in each captured image represented by the image data;
designating an initial object drawing area at an arbitrary position within a predetermined distance range which is visible by a driver among the recognized areas of a road, in an initial image which is one image of the consecutive captured images;
designating a subsequent object drawing area to a position where it corresponds to the initial object drawing area, in a subsequent image which follows the initial image among the consecutive captured images; and
generating data of an image obtained by adding an additional image of an arbitrary object to the object drawing area designated in each image of the consecutive captured images.
